(19) United States
(12) Patent Application Publication
(10) Pub. No.: US 2011/0223386 A1
(43) Pub. Date: Sep. 15, 2011

(54) GLASS ROLL AND METHOD OF PRODUCING THE SAME

(76) Inventors: Masahiro TOMAMOTO, Otsu-shi (JP); Toru SAKURABAYASHI, Otsu-shi (JP); Michiharu ETA, Otsu-shi (JP)

(21) Appl. No.: 13/041,570

(22) Filed: Mar. 7, 2011

(30) Foreign Application Priority Data
Mar. 12, 2010 (JP) 2010-056226

(51) Int. Cl. B32B 3/00; C03B 17/06; C03B 23/023

(52) U.S. Cl. 428/156; 65/106; 65/94

(57) ABSTRACT

Provided is a glass roll (1), which is formed by winding a long glass film (2) into a roll, in which the long glass film (2) includes both end edges (2a) in a width direction larger in thickness relative to a center portion (2b) in the width direction, and the long glass film (2) is wound into a roll so that the both end edges (2a) overlap one another while interposing a protective sheet (10) therebetween. Specifically, the long glass film (2) is formed by a downdraw method with selvage portions (2a) left in the both end edges in the width direction, and the long glass film (2) is wound into a roll so that the selvage portions (2a) overlap one another.

### TECHNICAL FIELD

The present invention relates to a glass roll, which is formed by winding a long glass film into a roll, and relates to a method of producing the same.

### BACKGROUND ART

As is well known, flat panel displays (hereinafter, simply referred to as FPDs) have become mainstream as image display devices in recent years, the FPDs being typified by a liquid crystal display (LCD), a plasma display (PDP), a field emission display (FED), an OLED display (OLED), and the like. Progress is being made toward reducing the weight of those FPDs, and hence glass substrates to be used for the FPDs are also currently becoming thinner.

Further, organic light-emitting diodes are used not only to flicker three fine primary colors with TFTs in displays such as an OLED, but also to emit monochromatic light (for example, white color light), and hence the organic light-emitting diodes are beginning to be used also as flat surface light sources such as a backlight of an LCD and a light source of an indoor lighting device. Further, in a lighting device using organic light-emitting diodes, the shape of its light-emitting surface can be freely changed if a glass substrate has flexibility. Thus, from the viewpoint of securing sufficient flexibility, progress is also being made toward a significant reduction in thickness of a glass substrate used in the lighting device of this kind.

In a pre-stage of production of the thin glass substrate to be used for those FPD, lighting device, and the like, in light of easiness of work and simpleness of handling in the production step, and even convenience in transportation, it is desired to wind a long glass film which is successively formed by a forming apparatus into a roll so as to form a glass roll. If the above is available, a thin glass substrate having a desired size applicable to the above-mentioned usage can be obtained by cutting the long glass film to a predetermined length while drawing it from the glass roll.

In producing this kind of glass roll, as described in, for example, Patent Literatures 1 and 2, it is necessary to wind the long glass film which is successively formed by a float method or a downdraw method after the cutting of its both end edges in a width direction. Such a process is required for the following reason. The both end edges in the width direction of the long glass film are supposed to be larger in thickness than its center portion and hamper winding of the long glass film, and hence it is recognized to be convenient to cut the both end edges in a pre-stage of the winding.

### CITATION LIST

### Patent Literature

Patent Literature 1: JP 2002-544104 A
Patent Literature 2: JP 2000-335928 A

### SUMMARY OF INVENTION

### Problem to be Solved by the Invention

By the way, in the methods of winding the long glass film described in Patent Literatures 1 and 2 described above, both end edges of the glass film are cut while the glass film is formed by a downdraw method or a float method and successively delivered. Thus, in order to form the molten glass into a thinner band-like glass film, it is necessary to accelerate a drawing speed of the forming apparatus and quickly draw the long glass film.

However, as the drawing speed is thus accelerated, a problem arises in that it is difficult to cut the both end edges of the glass film. In addition, if the cutting step is to be performed on the both end edges based on the accelerated drawing speed in order to avoid this problem, the cutting apparatus becomes more complex and larger, and an increase in production cost is inevitable, thereby making the problem even worse.

Further, in order to form a thinner long glass film while suppressing the acceleration of the drawing speed to avoid the above-mentioned problem, a reduction in glass flow rate is contemplated. However, a new problem arises in that as the glass flow rate becomes lower, stabilization of the flow rate becomes difficult, which is significantly disadvantageous in obtaining a long glass film having a stable plate thickness.

In addition, in the approaches described in Patent Literatures described above, a glass roll can be obtained by cutting the both end edges in the width direction of the glass film, followed by winding the successively formed long glass film. However, forming a glass roll after cutting the both end edges in this way leads to a state in which the entire surfaces of the glass film overlap and come into contact between adjacent layers of the glass film, with the result that the entire region including a product region is subjected to a load and vibration. Therefore, a critical problem arises in that the product region of the glass film has a flaw associated with sliding, a crack associated with impact, and the like. Such a problem cannot be completely solved by winding the glass film with a protective sheet interposed between adjacent layers of the glass film.

Moreover, the glass film after cutting the both end edges in the width direction has thin end surfaces (cut end surfaces) on both ends in the width direction. When the glass film is wound to be curved with a predetermined radius of curvature, the thin end surfaces are subjected to inappropriate tensile stress. Therefore, an occurrence of a damage such as fracture or a minor crack development in the thin end surfaces may cause the glass film to be broken.

Considering the above-mentioned matters, a conventional method of winding a long glass film not only inhibits a further reduction in thickness of the glass film, but also inevitably has an adverse influence on a product region of the glass film. This is significantly disadvantageous in quality and leads to a reduction in production yield.

In view of the above-mentioned circumstances, it is a technical object of the present invention to prevent a flaw due to sliding and a crack development from occurring on the product region of the glass film, while avoiding a problem with the drawing speed when winding the long glass film into a roll, thereby preventing a reduction in quality of the glass film and a reduction in production yield as much as possible.

### Means for Solving the Problem

The present invention, which has been made for achieving the above-mentioned technical object, provides a glass roll, which is formed by winding a long glass film into a roll, in which the long glass film includes both end edges in a width direction larger in thickness relative to a center portion in the width direction, and the long glass film is wound into a roll so that the both end edges overlap one another.

According to such a configuration, because the long glass film is wound into a roll in such a manner that its both end edges in the width direction, which are larger in thickness relative to the center portion in the width direction, overlap one another, adjacent layers of the glass film can be kept not to overlap one another in an area which is closer to the center portion in the width direction than the both end edges. Accordingly, it is possible to avoid mutual Contact of the center portion in the width direction. Thus, a load caused by transportation and handling of the glass roll mainly acts on the both end edges in the width direction of the glass film, and hence the load does not directly act on the area which is closer to the center portion in the width direction than the both end edges. Thus, a flaw due to sliding and a crack due to vibration are less likely to occur in the above-mentioned area. In addition to this, because the area which is closer to the center portion in the width direction of the glass film than the both end edges includes a product region (region effective as a product), an improvement in product quality, an improvement in production yield, etc. are obtained. Further, the both end edges of the glass film are relatively large in plate thickness, and hence not only is a minor crack less likely to develop, but the glass film can be used without any problem in terms of the product quality in spite of a flaw due to overlapping, as long as the both end edges are cut later. Moreover, it is unnecessary to cut the both end edges in the width direction of the long glass film, which is successively formed and delivered by a downdraw method or a float method, simultaneously with its delivery. Thus, an accelerated drawing speed does not cause any problem. As a result, the molten glass can be formed easily into a thinner long glass film.

In this configuration, the long glass film may be formed by a downdraw method with selvage portions left in the both end edges in the width direction, and the long glass film may be wound into a roll so that the selvage portions overlap one another.

In this way, the long glass film which is formed by the downdraw method (in particular, overflow downdraw method or redraw method), that is, the long glass film which includes the selvage portions at the both end edges in the width direction, is wound into a roll with the selvage portions left, the selvage portions being larger in thickness relative to the center portion due to contact with cooling rollers. Thus, the selvage portions preferably contribute to obtain the above-mentioned advantage. In other words, the selvage portions overlap one another to provide slip prevention in an axial direction of the glass film and protection of the product region of the glass film, thereby being effectively utilized for an improvement in product quality, etc.

In this case, it is preferred that the long glass film be wound into a roll so as to form layers overlapping one another while interposing a protective sheet therebetween.

In this way, not only is the glass roll itself less likely to be adversely influenced by the load and vibration, but the protection of the product region of the long glass film is more reliably ensured.

In this configuration, the protective sheet may be interposed only between regions corresponding to the both end edges of the long glass film.

In other words, the protective sheet is not required to be interposed between adjacent layers of the long glass film in the entire area in the width direction. If the protective sheet is not interposed between the product regions, as long as only the both end edges in the width direction overlap one another while interposing the protective sheet therebetween, the product region is sufficiently protected. Moreover, because the product region of the glass film is not accompanied with the protective sheet, an occurrence of transfer of stains or scratches from the protective sheet to the product region is avoided, and in the case of a particularly wide long glass film, the total width of the protective sheet can be extremely small, with the result that the material cost of the protective sheet is reduced.

In this case, it is preferred that the protective sheet include a cushion sheet and be formed of a resin or paper.

In this way, an impact-mitigating effect on the long glass film, and thus the glass roll, is sufficiently obtained, and it is possible to properly deal with the impact which may often be caused by handling and transportation. In this case, examples that can be used as the cushion sheet, other than paper, include thermoplastic resins such as an ionomer film, a polyethylene film, a polypropylene film, a polyvinyl chloride film, a polyvinylidene chloride film, a polyvinyl alcohol film, a polyester film, a polycarbonate film, a polystyrene film, a polyacrylonitrile film, an ethylene vinyl acetate copolymer film, an ethylene-vinyl alcohol copolymer film, an ethylene-methacrylate copolymer film, a nylon film, and cellophane, and foamable resins using those materials as a base material. Further examples include heat-curable resins such as an epoxy resin, a polyurethane resin, a phenol resin, a melamine resin, and a urea resin, and nonwoven fabrics using those thermoplastic resins and heat-curable resins as a base material.

In the above-mentioned configuration, it is preferred that the both end edges of the long glass film have a maximum thickness equal to or smaller than 0.5% of a winding diameter. In this case, the “winding diameter” refers to a minimum diameter formed by repeatedly winding the long glass film (the same shall apply hereinafter).

In other words, if the winding diameter is inappropriately small relative to the maximum thickness of the both end edges of the long glass film, the long glass film is wound with an extremely large radius of curvature at the both end edges, and hence a crack or fracture may occur at the both end edges due to insufficient flexibility or insufficient strength. However, if the maximum thickness of the both end edges is equal to or smaller than 0.5% of the winding diameter, sufficient flexibility or sufficient strength is obtained, and such a deficiency as described above is less likely to occur.

Further, it is preferred that the both end edges of the long glass film have a minimum thickness larger than 300 μm, and that the center portion in the width direction of the long glass film have a thickness equal to or smaller than 300 μm. Here, the thickness of the center portion in the width direction is equal to the thickness of the entire area of the product region.

In other words, the minimum thickness of the both end edges of the long glass film, which is larger than 300 μm, is significantly advantageous in protecting the product region of the glass film which is closer to the center portion in the width direction. Specifically, if the both end edges of the glass film have a considerable thickness, the both end edges do not undergo a significant change in its shape. Thus, it is possible to prevent the glass film from having a deficiency such as a wrinkle or a fracture due to the wrinkle when forming the glass film, and advantageously, it is easy to handle the glass film when winding it. Meanwhile, when the thickness of the center portion in the width direction of the glass film is equal to or smaller than 300 μm, a sufficient reduction in thickness is achieved to enable the glass film to be properly wound into a roll. Note that, an upper limit value of the minimum thickness of the both end edges is preferably 700 μm, or even 1000 μm, whereas the thickness of the center portion in the width direction relative to the minimum thickness of the both end edges is preferably within a range from ½ to 1/30.

The present invention, which has been made for achieving the above-mentioned technical object, provides a method of producing a glass roll which is formed by winding a long glass film into a roll, the long glass film including both end edges in a width direction larger in thickness relative to a center portion in the width direction, the method including winding the long glass film into a roll around a winding core of a winding apparatus so that the both end edges overlap one another.

According to such a method, the glass roll is produced by winding the long glass film into a roll around the winding core of the winding apparatus so that the both end edges in the width direction of the long glass film, which are larger in thickness relative to the center portion in the width direction, overlap one another. Further, matters including the effect described about the method of producing a glass roll is substantially the same as the matters described about the glass roll according to the present invention, which has essentially the same components as those of the method of producing a glass roll.

In the method, the long glass film may be formed by a downdraw method with selvage portions left in the both end edges in the width direction, and the long glass film may be wound into a roll around the winding core of the winding apparatus so that the selvage portions overlap one another.

Matters including the effect in this case is substantially the same as the matters described about the glass roll according to the present invention, which has essentially the same components as those of the method of producing a glass roll.

In the above-mentioned method, the long glass film, which is formed by the downdraw method and moves downward in an upright posture, may be wound into a roll while changing a travelling direction of the long glass film so as to cause the long glass film to move laterally in a laid-down posture using a plurality of rollers.

In this way, during winding the long glass film, the glass film is laterally moving in a laid-down posture (horizontal posture or reclined posture similar to the horizontal posture). Thus, the glass film becomes easy to wind, thereby facilitating a smooth winding operation.

Further, in the above-mentioned method, the long glass film, which is formed by the downdraw method and moves downward in an upright posture, may be wound into a roll without changing a travelling direction of the long glass film.

In this way, a length of a production line from the winding start to the winding end of the long glass film can be significantly reduced, and space saving is achieved.

### Advantageous Effects of Invention

As described above, according to the present invention, because a long glass film is wound into a roll in such a manner that its both end edges in a width direction, which are larger in thickness relative to a centerportion in the width direction, overlap one another, adjacent layers of the glass film can be kept not to overlap one another in an area which is closer to the center portion in the width direction than the both end edges, that is, an area which includes a product region. Thus, an improvement in product quality, an improvement in production yield, etc. are obtained. Moreover, it is unnecessary to cut the both end edges in the width direction of the long glass film, which is successively formed and delivered, simultaneously with its delivery. Thus, an accelerated drawing speed does not cause any problem. As a result, a thinner long glass film can be formed easily.

### BRIEF DESCRIPTION OF DRAWINGS

FIG. 1 A schematic side view illustrating how to produce a glass roll according to an embodiment of the present invention.

FIG. 2 A front view of a cross-sectional shape of a long glass film, which is a component of the glass roll according to the embodiment of the present invention.

FIG. 3 A half sectional front view of the glass roll according to the embodiment of the present invention.

### MODE FOR CARRYING OUT THE INVENTION

Hereinafter, an embodiment according to the present invention is described with reference to the accompanying drawings. Note that, the embodiment described below is directed to a long glass film as an original plate of a glass substrate to be used for an FPD, an OLED lighting device, or a solar cell.

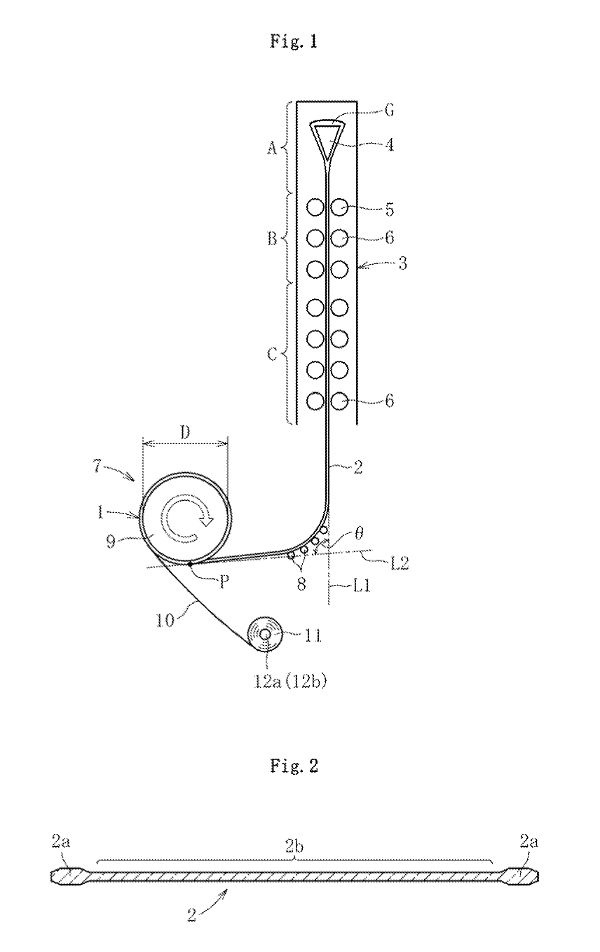

FIG. 1 is a schematic side view illustrating how to produce a glass roll according to the embodiment of the present invention. As illustrated in this figure, a ribbon producing apparatus 3 for forming a long glass film (hereinafter, referred to as glass ribbon) 2, which is a component of a glass roll 1, is used to carry out an overflow downdraw method. The ribbon producing apparatus 3 is configured to supply a molten glass G to a forming body 4 provided in a forming furnace and allow the molten glass G to be overflown from the forming body 4 and solidified while flowing downward, thereby producing the glass ribbon 2. While the molten glass G is allowed to flow downward and be solidified, the glass ribbon 2 in a state of an initial stage to a final stage is kept to be nipped on its both ends in a width direction between cooling rollers 5 and forming rollers 6 at a plurality of positions in a vertical direction.

Specifically, the ribbon producing apparatus 3 includes, starting from the top, a forming zone A for forming the molten glass G into an initial stage glass ribbon, an annealing zone B for removing an internal strain in the initial stage glass ribbon passed through the forming zone A, and a cooling zone C for cooling an intermediate stage glass ribbon passed through the annealing zone B to near a room temperature. Further, when the intermediate stage glass ribbon is passed through the cooling zone C, a final stage glass ribbon 2 to be delivered to a winding apparatus 7 is obtained.

In this way, the glass ribbon 2, which is passed through the cooling zone C of the ribbon producing apparatus 3 and is successively moving downward (vertically downward) in an upright posture, is curved under the effect of a plurality of (in the illustrated example, four) support rollers 8 to change its travelling direction so as to laterally move in a laid-down posture, and is subsequently wound around a winding core 9 installed in the winding apparatus 7. In this case, the winding core 9 in the winding apparatus 7 is disposed at a position which is laterally displaced from a position immediately below an exit of the cooling zone C. A tangential line L1 along the glass ribbon 2 which is passed through the cooling zone C and directed downward in the upright posture and a tangential line L2 along the glass ribbon 2 at a contact point P between the winding core 9 and the glass ribbon 2 are set to form an angle θ which is equal to or larger than 90 degrees. Further, in a region in which the glass ribbon 2 changes its travelling direction, the glass ribbon 2 is supported by the plurality of support rollers 8 from below, and hence is curved so as to smoothly extend across the two tangential lines L1 and L2.

Therefore, in the region in which the glass ribbon 2 changes its travelling direction, the glass ribbon 2 is not subjected to excessive stress. In addition, a winding operation is performed after the travelling direction of the glass ribbon 2 is changed to a lateral direction, and hence improved workability is achieved. Note that, in this embodiment, the glass ribbon 2 is curved to assume an arcuate shape inscribing with the two tangential lines L1 and L2.

Further, a sheet roll 11 is disposed below the winding core 9, the sheet roll 11 being formed by repeatedly winding a band-like protective sheet (or cushion sheet) 10 formed from paper or a resin. The glass ribbon 2 and the protective sheet 10 are wound around the winding core 9 into a roll, under a state in which the protective sheet 10 drawn from the sheet roll 11 is overlaid on the outer periphery side of the glass ribbon 2.

Here, as illustrated in FIG. 2, the glass ribbon 2 includes selvage portions 2a at its both end edges in the width direction, the selvage portions 2a being larger in thickness relative to a center portion in the width direction of the glass ribbon. The glass ribbon 2 is wound around the winding core 9 together with the protective sheet 10 while leaving the selvage portions 2a. In this case, a region which is closer to the center portion than the selvage portions 2a of the glass ribbon 2 is a product region (region effective as a product) 2b. The product region 2b has a plate thickness equal to or smaller than 300 μm, and more preferably equal to or smaller than 200 μm, whereas the selvage portion 2a has a minimum thickness larger than 300 μm, more preferably larger than 500 μm, and further, larger than 700 μm. Note that, in this embodiment, a widthwise dimension of the glass ribbon 2 is 100 to 2,000 mm.

Further, the sheet roll 11 as illustrated in FIG. 1 is formed by winding two protective sheets 10 separately in two positions in the width direction. Specifically, the two positions onto which the protective sheets 10 are wound correspond to the two positions in which the selvage portions 2a of the glass ribbon 2 are present, and each of the protective sheets 10 has a widthwise dimension which corresponds to a widthwise dimension of each of the selvage portions 2a. Note that, the sheet roll 11 may be formed by winding the protective sheets 10 around separate sheet winding cores 12a, respectively, or may be formed by winding both of the protective sheets 10 around a single sheet winding core 12b at two positions in an axial direction.

Further, a maximum thickness of each of the selvage portions 2a of the glass ribbon 2 is set to be equal to or smaller than 0.5% of a winding diameter D of the glass roll 1 (in other words, diameter of the winding core 9 illustrated in FIG. 1) formed by winding the glass ribbon 2. Accordingly, even if the glass ribbon 2 is wound around the winding core 9 while leaving the selvage portions 2a in the glass ribbon 2, tensile stress which acts on the selvage portions 2a does not exceed the strength of the selvage portions 2a, and thus it is possible to appropriately avoid any crack or fracture of the selvage portions 2a.

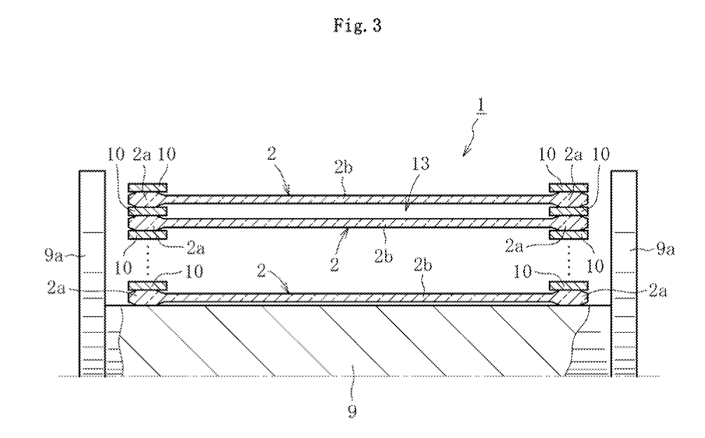

FIG. 3 is a half sectional view illustrating a schematic structure of the glass roll 1 formed by winding the glass ribbon 2 under the above-mentioned condition. As illustrated in this figure, the glass ribbon 2 is wound around the winding core 9 so that the selvage portions 2a in the both end edges in the width direction overlap one another. The selvage portions 2a overlap one another with the protective sheet 10 interposed therebetween. In other words, the glass ribbon 2 is wound around the winding core 9 so that the protective sheet 10 is interposed only between the selvage portions 2a overlapping one another. There is no protective sheet 10 interposed between the product regions 2b of the glass ribbon 2, but only a gap 13 is present therebetween. Note that, in this embodiment, flanges 9a are formed on both ends in the axial direction of the winding core 9, and both ends in the width direction of the glass ribbon 2 and inner surfaces of both the flanges 9a are spaced apart from each other.

According to the glass roll 1 having such a configuration, because the protective sheet 10 is interposed only between the overlapping selvage portions 2a in the both end edges in the width direction of the glass ribbon 2, it is possible to prevent the product regions 2b of the glass ribbon 2 from coming into contact with each other as much as possible. As a result, the load caused by transportation and handling of the glass roll 1 mainly acts on the selvage portions 2a of the glass ribbon 2, and hence not only a slip prevention effect, in particular, the slip prevention effect in an axial direction of the glass ribbon 2 is obtained, but the load does not directly act on the product region 2b. Thus, a flaw due to sliding and a crack due to vibration are less likely to occur in the product region 2b. As a result, an improvement in quality of a resultant glass film product, an improvement in yield, etc. are obtained.

Moreover, as for the glass ribbon 2 which is successively formed and delivered by the overflow downdraw method, its selvage portions 2a are not required to be cut simultaneously with its delivery. Thus, there is no problem with an accelerated drawing speed, and accordingly, the molten glass G can be easily formed into the glass ribbon 2 having a smaller thickness.

Note that, although, in the above-mentioned embodiment, the formed glass ribbon 2 changes its travelling direction at a position immediately below the cooling zone C, the glass ribbon 2 may be wound around the winding core 9 together with the protective sheets 10 without changing the downward travelling direction of the glass ribbon 2 in order to shorten the production line and to save space. Meanwhile, if a sufficient height from the forming zone A to the cooling zone C cannot be ensured, the glass ribbon 2 may be curved to laterally move in the laid-down posture using unlimited means at a transition stage from the forming zone A to the annealing zone B, and then the glass ribbon 2 may be formed by annealing and cooling.

Further, in the above-mentioned embodiment, when the glass ribbon 2 is formed, the selvage portions 2a, which are inevitably formed in the both end edges in the width direction by being nipped between the cooling rollers 5, are effectively utilized so as to be able to obtain the above-mentioned effect. However, the both end edges in the width direction of the glass ribbon 2 may be intentionally made larger in thickness than the center portion so as to obtain the above-mentioned effect by the presence of the both end edges.

Further, although, in the above-mentioned embodiment, the present invention is applied to the glass ribbon 2 formed by the overflow downdraw method, the present invention can be equally applied to the glass ribbon formed by a slot downdraw method or a redraw method, or even a float method.

### EXAMPLE

In the embodiment illustrated in FIG. 1, the inventors of the present invention studied a relationship between a thickness of the selvage portions (both end edges) 2a of the glass ribbon 2 and the winding diameter D of the glass roll 1. In this case, five kinds of glass ribbons 2, each of which includes the selvage portions 2a having a different thickness, were used, and as for each of the glass ribbons 2, the product regions 2b were set to have three kinds of plate thicknesses, 50 μm, 100 μm, and 200 μm. Note that, the selvage portions 2a were varied in thickness (maximum thickness) by variable adjustment of a nipping pressure of the cooling rollers 5 with respect to the both end edges in the width direction of the glass ribbon 2 at the time of forming and by variable adjustment of a heating temperature by a heater. Results of the study are shown in Table 1. Note that, in Table 1 as shown below, “∘” indicates that winding was performed without any problems and “Δ” indicates that the selvage portions 2a had more or less fractures and cracks.

TABLE 1

| | | Winding diameter of glass plate wound body (mm) | | | | |
|---|---|---|---|---|---|---|
| | | 300 | 600 | 1000 | 1500 | 2000 |
| Thickness of | 300 | ∘ | ∘ | ∘ | ∘ | ∘ |
| both end | 700 | ∘ | ∘ | ∘ | ∘ | ∘ |
| edges (μm) | 1,000 | ∘ | ∘ | ∘ | ∘ | ∘ |
| | 2,000 | Δ | ∘ | ∘ | ∘ | ∘ |
| | 5,000 | Δ | Δ | ∘ | ∘ | ∘ |

In Table 1 as shown above, in the case of the glass ribbons 2 which include the selvage portions 2a having a thickness equal to or smaller than 0.5% of the winding diameter D, all the results were “∘”, confirming that the selvage portions 2a had no crack or fracture at all. Meanwhile, in the case of the glass ribbons 2 which include the selvage portions 2a having a thickness larger than 0.5% of the winding diameter D, specifically, having a thickness ratio of 0.6%, 1.6%, or 0.83%, the results were “A”, indicating that the selvage portions 2a had more or less cracks and fractures. However, even if the result is “Δ”, as long as the crack and fracture are not developed and do not damage the product region 2b, the glass ribbon presents no problem as a product by finally cutting and removing the selvage portions 2a.

### REFERENCE SIGNS LIST

1 glass roll
2 long glass film (glass ribbon)
2a both end edges of glass ribbon (selvage portions)
2b product region of glass ribbon
7 winding apparatus
8 roller (support roller)
9 winding core
10 protective sheet
11 sheet roll
D winding diameter
G molten glass

1. A glass roll, which is formed by winding a long glass film into a roll, wherein the long glass film includes both end edges in a width direction larger in thickness relative to a center portion in a width direction, and the long glass film is wound into a roll so that the both end edges overlap one another.

2. The glass roll according to claim 1, wherein the long glass film is formed by a downdraw method with selvage portions left in the both end edges in the width direction, and the long glass film is wound into a roll so that the selvage portions overlap one another.

3. The glass roll according to claim 1, wherein the long glass film is wound into a roll so as to form layers overlapping one another while interposing a protective sheet therebetween.

4. The glass roll according to claim 3, wherein the protective sheet is interposed only between regions corresponding to the both end edges of the long glass film.

5. The glass roll according to claim 3, wherein the protective sheet comprises a cushion sheet and is formed of a resin or paper.

6. The glass roll according to claim 1, wherein the both end edges of the long glass film have a maximum thickness equal to or smaller than 0.5% of a winding diameter.

7. The glass roll according to claim 1, wherein the both end edges of the long glass film have a minimum thickness larger than 300 μm, and the center portion in the width direction of the long glass film has a thickness equal to or smaller than 300 μm.

8. A method of producing a glass roll which is formed by winding a long glass film into a roll, the long glass film including both end edges in a width direction larger in thickness relative to a center portion in the width direction,
the method comprising winding the long glass film into a roll around a winding core of a winding apparatus so that the both end edges overlap one another.

9. The method of producing a glass roll according to claim 8, wherein the long glass film is formed by a downdraw method with selvage portions left in the both end edges in the width direction, and the long glass film is wound into a roll around the winding core of the winding apparatus so that the selvage portions overlap one another.

10. The method of producing a glass roll according to claim 8, wherein the long glass film, which is formed by the downdraw method and moves downward in an upright posture, is wound into a roll while changing a travelling direction of the long glass film so as to cause the long glass film to move laterally in a laid-down posture using a plurality of rollers.

11. The method of producing a glass roll according to claim 8, wherein the long glass film, which is formed by the downdraw method and moves downward in an upright posture, is wound into a roll without changing a travelling direction of the long glass film.
